(19) United States
(12) Patent Application Publication
(10) Pub. No.: US 2007/0053335 A1
(43) Pub. Date: Mar. 8, 2007

(54) Mobile device address book builder

(76) Inventors: Richard Onyon, San Jose, CA (US); Liam Stannard, San Jose, CA (US); Leighton Ridgard, San Jose, CA (US)

Correspondence Address: VIERRA MAGEN MARCUS & DENIRO LLP, 575 MARKET STREET SUITE 2500, SAN FRANCISCO, CA, 94105, US

(21) Appl. No.: 11/437,554

(22) Filed: May 19, 2006

Related U.S. Application Data
(60) Provisional application No. 60/682,883, filed on May 19, 2005.

(51) Int. Cl. H04Q 7/24

(52) U.S. Cl. 370/338; 370/352

(57) ABSTRACT

Technology is provided to allow users of wireless mobile devices to propagate personal contact information to other users in an automated fashion. Users can create a “persona” of information which is made public, or destined for groups or individual friends, which is then distributed and added to the mobile device's address book or other data store in an automated or semi-automated fashion. A process for installing personification information to a first wireless device includes: detecting a communication initiation between the first wireless device and a second wireless device user; in response to said detecting, retrieving published persona information of the second wireless device user; and storing the published persona information in an address book on the first wireless device.

### CLAIM OF PRIORITY

This application claims priority to U.S. Provisional Application No. 60/682,883, filed May 19, 2005, entitled “Mobile Device Address Book Builder,” which is incorporated herein by reference.

### BACKGROUND OF THE INVENTION

### Description of the Related Art

Wireless telephones have become more powerful with the inclusion of such features as cameras, address books, calendars and games. Many now include microprocessors, operating systems and memory which allow developers to provide limited applications for the phones. Phones now include the ability to play multimedia files including polyphonic ringtones, MP3 files, MPEG, AVI and QuickTime movies, and the like, in addition to displaying pictures taken on or downloaded to the phone.

Wireless phones have long been able to access the Internet via a Wireless Access Protocol (WAP) browser, and receive messages via SMS. A user on a wireless telephone connects via the wireless network to a server which enables the phone to read WAP enabled content. Most providers enable a user to access an email message account via the WAP browser, and/or provide short message service (SMS) messages directly to the user's phone. SMS allows users to receive abbreviated text messaging directly on the phone. Messages can actually be stored on the phone, but the storage available is limited to a very small amount of memory. In addition, no provision for handling attachments in SMS is available.

More recently, phones themselves have become powerful enough to utilize data connections over a carrier's network to manipulate data. For example, users of a carrier's network can download multimedia content to their phone, shop and download phone specific applications, and send and receive more robust messaging. Devices which have been combined with wireless phones, such as Research In Motion's Blackberry device, provide a user with enhanced message capabilities and attachment handling. These devices are specifically configured to provide contact and message applications over a wireless network.

Still, the majority of phones provide limited native address and contact data storage, and only SMS messaging capability. Some phones allow users to associate images and specific ringtones with users in their phone's address book. Most wireless phones support caller ID, which displays the number of an incoming caller. Using this information, phones having imaging and multiple ringtone capabilities display an incoming caller's address book associated picture (if available) when the incoming call is received, and play a specially designated ringtone (if specified).

With the numerous different types of wireless phones and other communications devices available, a system which will enable a user to provide a personalized representation of themselves on other user's phones would be useful in allowing the user to identify themselves to other users.

### SUMMARY

The technology allows users of wireless mobile devices to propagate personal contact information to other users in an automated fashion. Users can create a “persona” of information which is made public, or destined for groups or individual friends, which is then distributed and added to the mobile device's address book or other data store in an automated or semi-automated fashion.

In one aspect, the invention includes a process for installing personification information to a first wireless device. The method includes: detecting a communication initiation between the first wireless device and a second wireless device user; in response to said detecting, retrieving published persona information of the second wireless device user; and storing the published persona information in an address book on the first wireless device.

In a further aspect, the invention includes a computer implemented process for transferring user published persona information to a first wireless device. The process includes receiving said user published persona information; detecting a communication between the first wireless device and the user operating a second wireless device; and forwarding the user published persona information to the first wireless device.

In another aspect, the invention includes a computer implemented process for automatically installing user defined persona information to a contact store on a wireless device. The process includes: maintaining a data store of user defined persona information for a persona information service subscriber; detecting a communication between the subscriber and a wireless device user; and providing user defined persona information for the subscriber from data store to the wireless device via the wireless link.

### BRIEF DESCRIPTION OF THE DRAWINGS

FIG. 1 is a flow chart illustrating a method in accordance with the present invention.

FIG. 2 is a flow chart illustrating a second method in accordance with the present invention.

FIG. 3 is a block diagram of a system suitable for implementing the identification system of present invention.

FIG. 4 is a block diagram of a method of the present invention.

### DETAILED DESCRIPTION

The present invention allows advanced identification features to be provided to a phone or other mobile device by allowing user to provide personification information for other users of advanced wireless communication devices. A subscriber's contact information can be provided to a user that the subscriber calls under the control of a server and/or system enabled user phone.

In general, a user creates a personification of themselves which may include the user's contact information, signature, photo, multimedia information and a specific ringtone identifying them to other phone users. Many cellular phones include the ability to download specific ringtones and use them to identify incoming callers by associating the ringtone and picture with the contact information in the phone and triggering it using caller ID functions. The system of the present invention allows the user to specify their own ringtone and picture, and use it to identify them to other users. In addition to the static information in the personification information a user may provide dynamic information such as GPS location, timezone, availability, and event-relevant information (e.g., a reminder it's the caller's birthday, or a summary of calendar events or tasks assigned to or by the caller) or control information to other users or participants.

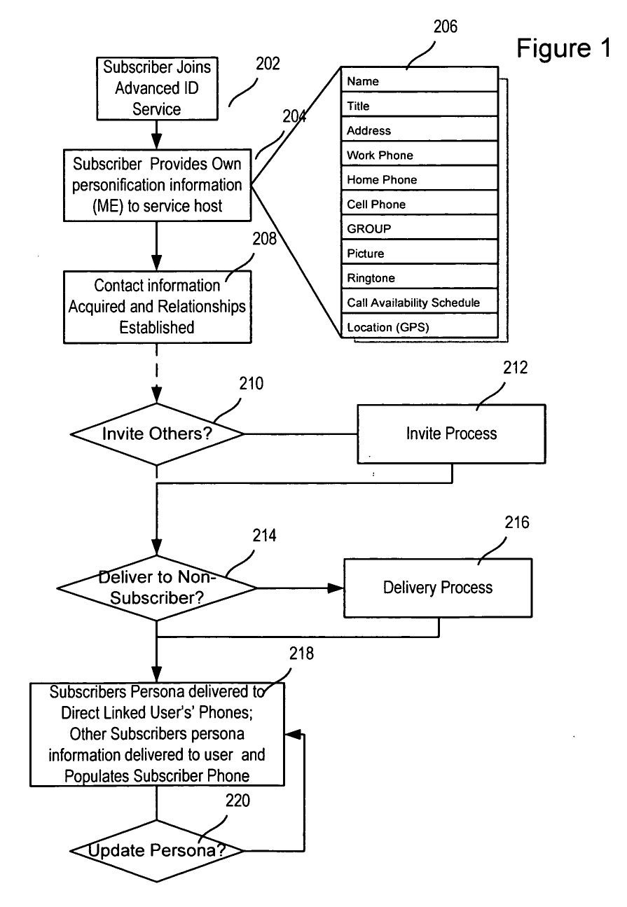

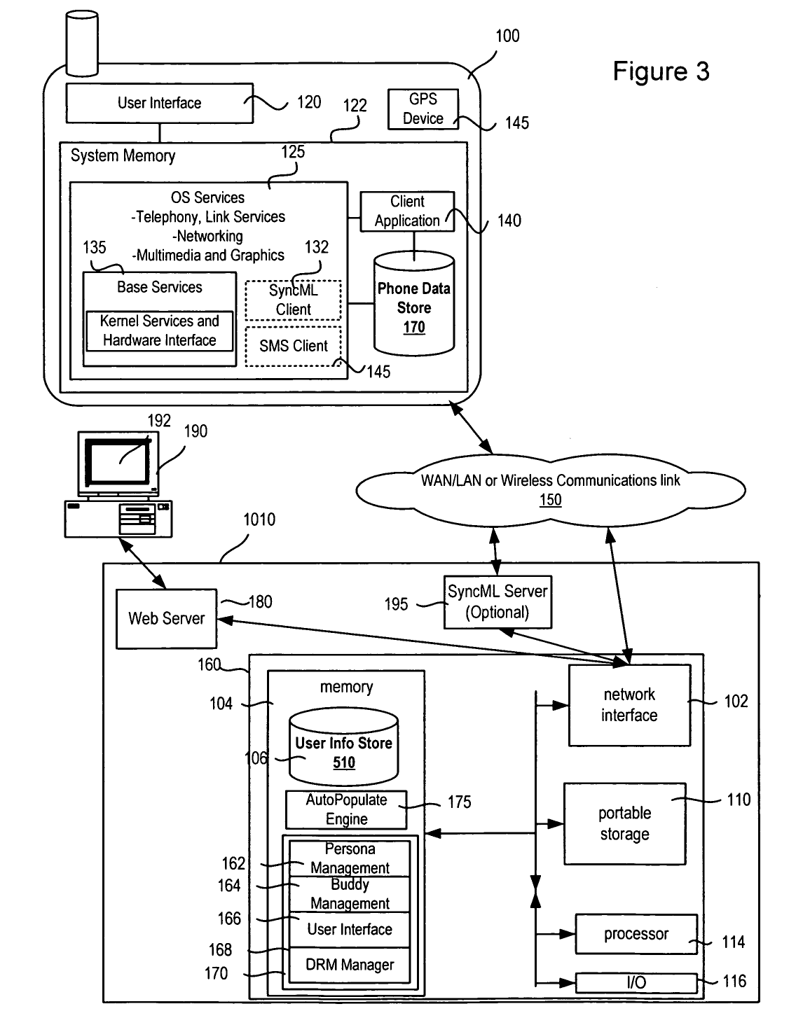

FIG. 1 illustrates a general method in accordance with the present invention. At step 202, a subscriber access personification service by providing account creation information. As discussed below, the personification service may be provided and maintained by an enterprise service provider. The service provider may provide one or more servers (described with respect to FIG. 3 in a computing environment 1010), which link to one or more mobile devices, optionally referred to herein as “clients.” At step 202, the user may establish an account using a user name, a secure password, and provide other configuration information. This step may be performed via a phone based interface or via a web based interface, or any other suitable interface means.

At step 204, the user may create the user's own personification information. This is referred to in Figures occasionally as creating or updating “me”. As shown at table 206, the user personification data may include the user's name, address, phone number and any other contact information, a picture of the user, a specific ringtone for the user, and a schedule of available times that the user may be contacted in various manners. In addition, the user may input user location information. Location information may be of varying specificity, and may initially input manually or through a connection with a GPS system in a GPS enabled phone. Information in the location section of a user's system may be updated by an agent on the phone using the phone's GPS capabilities. The ringtone may be uploaded by the user or may be selected from tones provided by the system administrator as part of the service, or the user may use the device's microphone (if equipped) to author a new audio clip which will be used as a ringtone. Optionally, a value added media distributor may provide phones, and digital rights management incorporated in the system to ensure proper control of copyrighted material within the system of the present invention. The phone manufacturer, the mobile phone carrier, or another entity may add DRM functionality as well, which may determine which protected content may be redistributed (and how). It should be recognized that step 204 is optional, and a user may decide not to provide personification information, but only participate in the system to acquire personification information of others. In another embodiment, subscription to the advanced ID service provided by the ESP is not required to receive personification information.

As discussed in further detail below, different sets (or “personas”) of personification information may be provided for different groups of individuals in the users' contact information. For example, a user may wish one group of contacts to receive one set of personification information (such as business contacts), while another set (such as personal friends) to receive a different set of information. A group definition allows the user to define recipients who receive the particular version of contact information. The user may assign one or more users to a particular group using an interface provided on the mobile device, or alternatively via some other interface, such as a webpage or an administrative configuration console. Additionally, the user can specify a “public” persona which anyone may download (and will be automatically assigned to new contacts in the user's devices). The service maintains group assignments in persistent storage. The service transmits the information appropriate for each group to the members of the group using the above described techniques. An enterprise service provider can allow a user to have a default persona upon establishing an account with the system. For example, the system can establish default public friends, family, co-workers, business associates, and blacklist persona templates, allowing the user to input certain information and have established personas once the user joins the system. The blacklisted persona is intended to be assigned to buddies to whom the user does not want to publish information.

At step 208, the new subscriber's contact records are provided to the service in one of a number of ways, and relationships detected between the subscriber's contact records and other subscribers. This input may be as simple as downloading phone numbers that the user has stored in his phone, or may include additional contact information which allows the system to determine whether individuals are members of the system. In addition, the subscriber may manually input contacts during account creation, or download contact information from another source, such as a personal information manager on a personal computer or personal digital assistant. A search mechanism may also be provided, allowing the user to input information on individuals to determine whether an individual is part of the system. For example, if a user does not have a stored resource of personal information, the user may, via the web browser, access a form provided by the system administration which provides name and other contact fields which the system can use to search for other users participating in the system. Once, found, this information can then be provided to the user.

User persona information may be associated with the user's phone number when stored, and accessed relative to that phone number. In one embodiment, the personal information is implemented and displayed on users phones in a manner as disclosed in U.S. patent application Ser. No. 11/128,121.

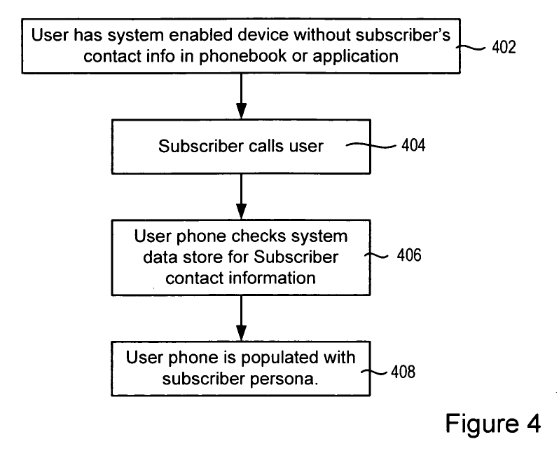

In accordance with the system of the present invention, different types of links may be established automatically between users to allow for transmission, display and updating user address books. Generally, a user's contact list is found in the user address book in the datastore of the phone. Due to the nature of human communication, it is likely that a contact in a person's address book can likewise be found in that contact's own address book. For example, assuming Bob and Alice are both friends, they will likely have each other's contact information in their respective address books. This reciprocal link between people can be utilized to recognize and distinguish different types of links. In another aspect, “half” linked users occur when one user has the other user's contact information in their address book, but the other user does not reciprocate. These users are not connected for purposes of data exchange and the invitation functions described below with respect to FIGS. 4 and 5 may be offered to the unlinked user giving them the opportunity to subscribe to the system and establish a true link with the inviter. “True”- or “direct” linked users exist when both users have each other's contact information in their mobile device's phone book. These users have established some level of relationship outside of the service or via an “Invitation” function, and will automatically exchange and maintain any information each user has configured. Within a context of the foregoing description, a “buddy” is any user who has established a true link with an individual user. For privacy as well as practicality, information exchange in the service occurs only between true linked users. Users who possess only a half-link to one another may invite the half-linked user to join the system and establish a true link.

When the user provides their own personification information to the service host at step 204, step 208 may include a step of detecting links between users by examining the contents of their address books which are provided to the service. In order to identify each user from the pool of all users of the system, the service uses telephone numbers and in one embodiment e-mail addresses as unique keys. In a further embodiment, the service can use telephone number equivalence algorithms to match phone numbers regardless of formatting, country and area codes.

Users who wish to remove their information and “unlink another user” simply remove that user from their mobile device's address book. Using the rules of the service, the two users are no longer linked and no further updated information between them occurs. No information is deleted from the unlinked party's address book in this process. To accomplish this, instead of unlinking users may wish to assign another user to a “blacklisted” persona.

At step 208, once the contacts have in acquired, relationships between the subscriber's contracts and other subscribers are established. This can occur automatically by an algorithm run by the ESP, may be set manually by the user, or may occur by some combination of the two.

Optionally, at step 210, the subscriber may be offered the opportunity to invite other people to become subscribers. The user may be prompted to determine if the user wishes to invite contacts stored in the users phone to become subscribes to the service to obtain additional benefits attributable to subscription. If the user wishes to invite others, an invite process is performed at step 212.

Optionally, at step 214, the subscriber may be given the option to allow their persona to be provided to non subscribers. If the user desires their information to be delivered, a delivery process 216 transmits personification information to non-subscriber users. This may occur in any number of ways, such as for example via a direct data link, via SyncML, or via SMS messages, as described below.

At step 218, personification information from other subscribers in the subscriber's contact list are delivered to the new subscriber, and the new subscriber's information sent to other subscribers. As discussed below, contacts who are also subscribers are true-linked users 210 and automatically populate the new subscriber's phone. The information may be transmitted to the user in a data stream directly to the agent, which then populates the user's phone data. Alternatively, the information may be provided in a series of messages. Preferentially, the information will be transmitted via SyncML.

Included in persona information is whether the subscriber's contacts should be alerted to the subscriber's location based on system subscriber's GPS or manually entered location information in their own record. Also included may be, for example, the level of granularity available to the subscriber's contact. For example, one may be allowed to know the country, city or a more specific location. Once received, the receiving member may further configure the subscriber's persona information based on the information received. For example, suppose another member provides location information in their member record. The user may specify that the user wishes to be notified when the member with location information moves to a particular location or within a particular distance from the specifying member. Other criteria may also be configured, such as group information. For example, the user may specify which groups each member belongs to so that if such member requests personification information about the specifying user, the correct group information is provided to the requesting member.

Finally, at step 220, the new subscriber may update information in their persona. When the new subscriber does so, the information is re-transmitted to true linked subscribers and, if enabled, non-subscriber participants in the system. Updates may be started on the device by the client application as a result of data changes on the device. This may occur because of user interaction with the device, or changing transient information such as time zone. Updates can occur in one of two ways. Server-initiated updates are triggered by time intervals, or a change in data which is to be sent to the user's device. Server-initiated updates are handled via direct socket connection to the client or via SMS messages sent from the server to the client application on the device. Each advanced ID account supports a configurable “server initiated sync on/off” setting which controls whether SMS messages are automatically sent when a client is out of date. The SMS message from the server may be sent to the text port (or configured data port, if appropriate).

FIG. 3 shows the method of the present invention once a subscriber has established a relationship with the enterprise service provider in accordance with the present invention and installed the application 140 on the user's phone 100. At step 500, when a Subscriber B receives a call from another member (subscriber A) who has downloaded the user's information into the user's phone, advanced caller identification features can provide a member's information at step 506 on the user's phone.

In one aspect, the system supports controlling both the calling user's phone and the called user's phone. At step 501, if subscriber B has configured his persona (which is downloaded to subscriber A) to prevent calls during a certain period of time, the client application on the calling user's phone can prevent subscriber A from connecting to subscriber B during this period. Hence at step 501, the method may check (on subscriber A's phone) whether a call to Subscriber B is allowed based on Subscriber B's configuration. If not, an alert 503 may be provided to Subscriber A indicating the call cannot be put through. Optionally, no alert is provided.

At step 502, if the call is within an allowable time, the call is initiated by subscriber A received by subscriber B. Optionally, at step 504, the receiving user can configure the phone to prevent calls during a specific period of time. Hence, at step 504 the method may check to determine whether a call is allowed during a specific period by the receiving user. If the call is not allowed, the technology may block the call at step 512. If the call is not blocked, the user's advanced ID information (persona) is displayed on the receiving caller's phone. If the call is blocked, it may be directed to the receiver's voicemail system. The advanced ID or persona is a collection of information which defines the user, such as a phone number, e-mail address, picture, geo location information and other data. This allows subscribers to manage their own “personal brand” controlling how they are represented on other user's phones specifying a ringtone or the picture associated with their contact. As discussed herein, one can have a “friends” persona and a “co-workers” persona which contain different information or different sets of information. Additional features such as GPS location information provided by GPS information capable phones is also provided, as is information about the caller which is transient in nature—such as whether it's the caller's birthday or anniversary, or information concerning phone calls, meetings, or tasks assigned to or by the caller.

Optionally, at step 508, if the member has chosen to provide the member's GPS information, at step 508 the GPS can be provided in a notification at step 510 provided to show that the user is at or near a specific location.

The present technology supports two different types of data: static and dynamic. Static data can include a user's ringtone, name and image. The static info is provided by the calling subscriber to the receiving subscriber's client on phone 100 at step 506. Step 501 is an example of a feature of the present invention which allows subscribers to define their own personification information to control another user's phone—this dynamic or “active control” information can be updated more often than the static persona information. Dynamic information such as GPS or timezone information is updated regularly based on the needs of the sending subscriber. Due to the interaction of the client 140 with the phone, the subscriber may actually prevent (or merely warn) a calling subscriber from calling a receiving subscriber's phone and may instead provide them a user-configurable message which may direct the caller to use some other mechanism to contact the intended receiving subscriber (e.g., SMS, email, etc). As with all other similar information, this preferred availability information is stored users' personas.

FIG. 3 illustrates a general overview of a system for implementing the present invention. As shown in FIG. 3, a wireless communication device, such as a phone 100, is connected to a wireless communications link, such as a cellular network 150, to transmit voice and data communications to other devices coupling to the wireless network. It will be understood that the wireless link may be a wireless internet link or a cellular network maintained by a cellular carrier, a GSM or CDMA network, or some other wireless communications link. The carrier may comprise the enterprise service provider or may be separate from the enterprise service provider. Data may be transmitted over the network in any number of known formats. The system may be implemented by using a direct push system from a server via a SyncML server to a SyncML client, or may be operated on by a specific client application resident in the phone which communicates with the service-side implementation. SyncML is an Extensible Markup Language (XML) protocol under development as an open standard for the universal synchronization of data between devices. Synchronization of data allows changes made to data on one device (such as a smartphone or a laptop computer) to be instantly reflected in data on another device (such as a networked computer).

As noted above, an enterprise service provider may provide the personification service utilizing a computer environment 1010. Environment 1010 includes an advanced ID service server 160 which communicates with the telephone via wireless link 150 directly over a data connection or via a SyncML server 195. Various embodiments of a system for implementing the advanced ID service are discussed herein. In FIG. 3, the ID server 160 communicates directly with the phone 100. In alternative embodiments, discussed below, the ID system is implemented on top of a synchronization system such as that described in U.S. Pat. No. 6,671,757, 6,694,336 or 6,757,696.

Wireless device 100 may be provided with a persona application or agent 140. Persona agent 140 can include a SyncML communication client designed to interact with a SyncML server 195 in accordance with approved and proposed versions of the SyncML OMA DS specification, including proposed extensions, (available at http://www.openmobilealliance.org). Alternatively, personal application 140 can be an application designed to communicate with server 160 using an existing SyncML client on the phone provided by the phone's manufacturer (as well as any custom extensions supported by such client), or an application specifically designed to communicate with server 160 via another protocol, including a proprietary protocol. In one embodiment, the agent 140 is a fully implemented SyncML client and server 160 includes a SyncML server. In another embodiment, the application 140 includes a device sync agent such as that disclosed in U.S. Pat. No. 6,671,757. Various embodiments of the persona application 140 are set forth below.

In accordance with the present invention, a phone 100 includes a system memory 122 which may further include an operating system 124 having operating system service including telephony and linking services, networking services, multimedia and graphics display services all provided to a user interface 120. OS 125 my be the phone's proprietary OS, BREW, or any other device or operating system suitable for a phone (such as the Symbian Operating system). Additional base services 135 and an operating system kernel may also be provided. The operating system may additionally provide an SMS client 145 built into the operating system allowing short messages to be provided across the wireless communications line 150 to other users. Still further, a SyncML client 132 may be provided and supported by the operating system services 124. The phone 100 includes a native phone data store 170 which contains address book contact and other information which may be provided by a subscriber. Such information can further include ringtones, pictures, sounds, and movies, all dependent on the functional capabilities of the phone 100, the space allowed in the system memory, and the services provided by the operating system 124. Device 140 may also include a GPS device 145 which interacts with a GPS service in OS services 125.

Persona application 140 is also loaded into phone 100 in any number of ways. As will be well understood by one of average skill in the art, application 140 can be provided by the device manufacturer directly into the device or downloaded by a user at a later time. To download and install the application, the user selects a download area of the device operating system services 124, selects the application from offerings provided by the service provider or carrier who maintains the wireless communications line 150, or an enterprise service provider who maintains the system server 160, and installs the application onto device 100. In an alternative embodiment, agent 140 is a self-supporting application designed to run as a JAVA or BREW agent, or any other device or operating system specific agent (such as an agent operable on the Symbian Operating system). This agent 140 can either include its own SyncML client, or interact with an existing SyncML client on the devices. Changes can occur at field level or byte level. Alternative embodiments can communicate via alternative protocols via the wireless communications link to store information on the System data base 510.

Client 100 includes at least a user interface 120, the application 140 having a communication or sync engine and data store manager, a SyncML client 132 and a local database 150. The client application 140 provides an appropriate graphical user interface to UI 120 which provides the user an alternative point of interaction with the system and service provided by the enterprise service provider. The user interface allows the user to define and manage personas and buddies as well as other tasks as specified in the case definition described herein. Interaction with the system can be via this client user interface or via the server user interface provided by the web server 180. The engine and data store manager is responsible for maintaining the user settings and options in the device's persistent storage as well as automatically pushing and retrieving changes to those object to the system server. The client datastore includes account information, persona data, buddy information, data for other users who have true links with the subscriber, and multimedia content

The storage server 160 is a centralized storage location for all system service information, including buddy, persona, relationship, and user data. Clients 140 can connect to and synchronized with the server information to update their local copy of this data as well as publish any changed information or retrieve any new available information from the server. In the mobile device, the persona information belonging to a user's buddy is primarily stored in the native address book or a separate address book provided by the client. As some devices will not support all the published buddy information including the extended information such as geo location and presence information, the client can store this information in a local database and provide access to it via the phone interface.

In general, a hardware structure suitable for implementing server 160, webserver 180 or SyncML server 195 includes a processor 114, memory 104, nonvolatile storage device 106, portable storage device 110, network interface 112 and I/O device(s) 116. The choice of processor is not critical as long as a suitable processor with sufficient speed is chosen. Memory 104 could be any conventional computer memory known in the art. Nonvolatile storage device 106 could include a hard drive, CDROM, CDRW, flash memory card, or any other nonvolatile storage device. Portable storage 108 could include a floppy disk drive or another portable storage device. The computing system may include one or more network interfaces 102. An example of a network interface includes a network card connected to an Ethernet or other type of LAN. I/O device(s) 116 can include one or more of the following: keyboard, mouse, monitor, display, printer, modem, etc. Software used to perform the methods of the present invention are likely to be stored in memory 104 which include nonvolatile storage and volatile memory as well as, portable storage media 110.

The computing system also includes a database 106. In alternative embodiments, database 106 is stored in memory 104, portable storage 110 or another storage device that is part of the system of FIG. 3 or is in communication with the system of FIG. 3. Other alternative architectures can also be used that are different from that depicted in FIG. 3. Various embodiments, versions and modifications of systems of FIG. 3 can be used to implement a computing device that performs all or part of the present invention. Examples of suitable computing devices include a personal computer, computer workstation, mainframe computer, handheld computer, personal digital assistant, pager, cellular telephone, smart appliance or multiple computers, a storage area network, a server farm, or any other suitable computing device. There may be any number of servers 160n, n+1 managed by a system administrator providing a back up service in accordance with the present invention.

Also provided on server 160 is a user info data store 510. The System data store 510 is provided in the non-volatile memory space of server 160. While only one data store 510 computer is shown, it should be recognized that the store may be replicated to or stored over a plurality of computers to ensure that the data thereon is protected from accidental loss. It should be understood that the representation of the SyncML server 195 and web sever 180 need not require that such servers be provided on different physical hardware than the server 160.

The system of FIG. 3 illustrates one server and client system suitable for use in the present invention. In an alternative embodiment of the invention, the advanced ID system can be constructed using a synchronization server described in U.S. Pat. Nos. 6,671,757, 6,694,336 or 6,757,696.

A synchronization system described with respect to U.S. Pat. Nos. 6,671,757, 6,694,336 or 6,757,696 comprises client software which provides the functions of a differencing transmitter/receiver/engine, and differencing synchronizer in the form of a device engine. The device engine may include at least one component particular to the type of device on which the device engine runs, which enables extraction of information from the device and conversion of the information to difference information, and transmission of the difference information to the storage server. The storage servers utilized in the may be any type of storage server, such as an Internet server or an FTP server, and may be provided from any source, such as any Internet service provider. In a key aspect of the sync system, the Internet connection between the devices or between the devices and a server need not exist at the same point in time. In addition, only those changes to the information which are required to be forwarded to other systems on the system of the present invention are transmitted to enable fast response times.

Data from each of the sync client devices is coupled with a storage server. In one embodiment, each device engine implements all processing required to keep all the systems fully synchronized. Only one device engine needs to be coupled to the sync server at one particular point in time. This permits synchronization of multiple systems in a disconnected fashion. Each device engine will download all transactions encapsulating changes that have occurred since the last synchronization from the server and apply them to the particular device. The change or difference information (termed a “data package” or “change log”) is provided in one or more data packages. Each data package describes changes to any and all transfer information across all device engines, including but not limited to application data, files, folders, application settings, and the like. Each device engine can control the download of data packages that include classes of information that apply to the specified local device. For example, contact names and phone numbers while another needs only changes to e-mail, changes to document files.

Compression and encryption of the data packages may be optionally provided. Each device engine performs mapping and translation steps necessary for applying the data packages to the local format required for that type of information in the application data stores. The device engine also includes components which allow it to track ambiguous updates in cases where users have changed data to a particular data field on two different systems simultaneously since the last update. The output of the device engine comprises a data package which is output to sync server database. As noted above, only one device engine need be connected to the storage server at a given time. The data package can be stored on the storage server until a request is made to a particular location of the storage server by another device engine. Access to areas of the storage server is controlled by a management server (MS). In one embodiment, each sync operation requires that the device engine for each device login to the management server to authenticate the device and provide the device engine with the location of the individual device's data packages on the storage server.

When data is returned to the delta module from the storage server, the delta module returns differenced data to the application object for the particular application which then translates the delta information into the particular interface utilized for application. Once a device engine has been fully applied all data packages from an input stream, it generates a series of data packages that describe the changes made on the local system. The device engine uses the local application object 920 to keep track of the last synchronized version of each application's actual data, which is then used for the next data comparison by the delta module on the next sync request. Generated data packages can include operations and encode changes generated from resolving ambiguous cases as described above.

The sync server uses the concept of a universal data record in its internal sync differencing engine and when sending data to and retrieving from external

The management server supports an authentication interface that requires each device engine to authenticate with the management server before performing synchronization. Certain storage server implementations may utilize locking semantics to control read and write access to storage for multiple device engines. For example, in a generic FTP request, if two device engines attempt to connect to the same data at the same time, there must be some form of locking control to prevent device engines accessing the same data at the same time. In this instance, the management server controls the device engine acquisition, renewal, and releasing of locks against data stored in the network.

Each device engine is uniquely identified and tracked by the management server. This allows for tailoring behavior between the management server and specific types of storage systems and device engine components. All device engine components are tagged and version stamped for management via the management server.

Also shown in FIG. 3 is a server-side application ID service controller application 170 which includes a persona management component 162, a buddy management component 164, a user interface 166, and a digital rights manager 168. It will be understood in various implementations of the present invention, the functional components operating within the service-side application 170 can come in one case, push information maintained by the system of the present invention directly into phone 100 via a SyncML server 195 interacting with a fully robust SyncML client. Optionally, certain aspects of the control are handled by either the server-side application 170 or the client-side application 140, as described herein.

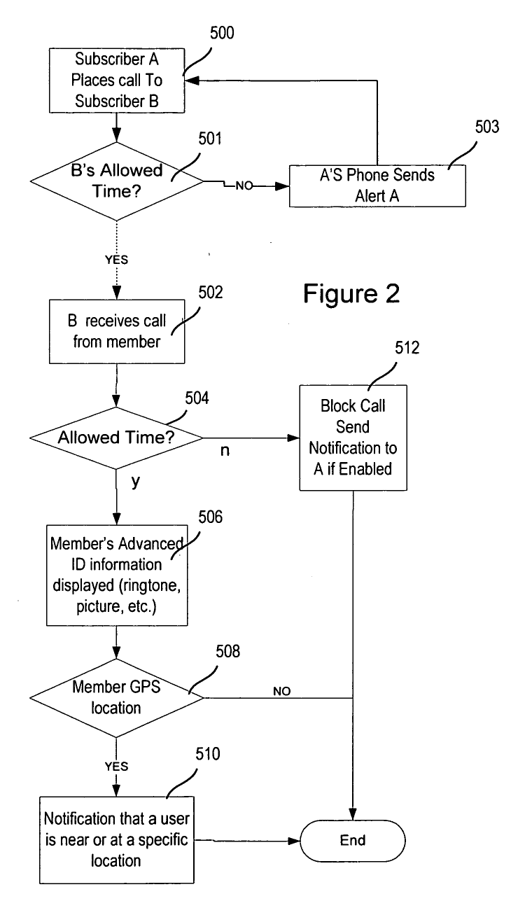

Also shown in FIG. 3 is an auto populate engine 175 which implements server-side aspects of the methods shown in FIGS. 1, 2 and 4.

In accordance with the invention, application agent 140 communicates personification information and changes made to the personification information stored in the data store of the telephone 100 to server 160 via the wireless network. Communication of user data from the device may take several forms. Where the client utilized SyncML communications with the server 160, communication may take place using the standards set forth in the SyncML specification. Changes are transmitted on a record-by-record basis or field-by-field basis. Alternatively, communication may occur via another protocol. The SyncML client is utilized to update the phone's native address book with buddy published information as well as to retrieve persona and link information from the server. Information can be exchanged via the SyncML protocol, or via a direct data link with the server 160. The system server stores and maintains each user account, link personal and buddy information as well as multimedia content, both system provided and user created. The server is a stand alone server and may be incorporated with the features of a synchronization system such as that described in U.S. Pat. No. 6,671,757. Details of this integration are described in further detail below. As noted above, a management interface is provided via the web server 180. Description of this interface is shown below.

The server 160 stores user data in the personification store 510 in a manner which associates the data with the user of the phone. In one embodiment the data is stored in bulk—that is all records and information for the user are stored in simple text form, (or binary form, depending on the type of data in use). This information is stored in the data store using a unique identifier (UID) associating the personification data with the individual user. The identifier may be any randomly selected identifier, so long as the user is uniquely identified, and the data is associated with the user. In a further aspect, this user UID may be a universally unique identifier (UUID), created in a manner described in the aforementioned U.S. Pat. No. 6,671,757, 6,694,336 or 6,757,696.or other manners to create a single ID for a given user. In yet another embodiment, user data and changes to the user data are stored in a change logs in a manner described in the aforementioned U.S. Pat. Nos. 6,671,757, 6,694,336 or 6,757,696.

A web server allows a user on a computer or other device 190 having a web browser to configure aspects of the system of the invention. Server 180 may have a hardware configuration similar to computer 160 and may comprise one or more physical computers. Additionally, web server 180 may be integrated with server 160. Persona configuration card service sign-up may be completed in an interface provided by web server 180. This includes the configuration options for static and dynamic information as discussed herein.

In one embodiment, aspects of the system of the present invention are configured via a phone interface 120. The system can alternatively be configured by a user via a web interface provided by the web server 180 via the user device 190.

FIG. 4 shows a further aspect of the present invention which include an automatic phonebook population feature which may be performed by the client and/or the server in accordance with the present invention. At step 402, a user who has a system enabled phone but who's address book in the phone does not have a subscriber's information (or who has a subset of the subscriber's defined information) as maintained by the store 510 can auto-populate the user's device with the subscriber's information. In this embodiment, the user enabled device may be a device 100 wherein the persona application 140 is specifically adapted to work with a server 160 having an auto populate engine 175 running in memory 104 which cooperates with persona 140 to implement an auto populate sequence. Alternatively, the persona application 140 may include other functions as well. Alternatively, the device 100 may have a robust SyncML client which may be instructed by an auto populate engine on the server to perform the necessary steps discussed herein. The user in step 402 may be a system subscriber or simply an enabled user as discussed above.

At step 404, when a subscriber having information in the user data store in the form of a persona or other user-centric contact information phones an enabled user, a determination is made (automatically or by the receiving user) as to whether the receiving user has the caller's contact information in the receiving user's device. This determination of whether the calling user's contact information is in the user's device may include an automatic determination performed without user intervention by the client application, a prompt to the user in the form of an alert upon receipt of a call from the subscriber or after completion of the call from a subscriber (e.g. “do you want to add “subscriber” to your contact book?”), an SMS message generated by the server or the calling subscriber's phone prompting the user to add the subscriber, or some other form of alert. If the user so instructs, or if the client application on the user's device is configured to check automatically, the user device or server can check the system data store 510 for information on the subscriber which is compatible with the receiving user's phone At step 410, the user device may be populated with the subscriber's information. This may include providing the subscriber's information to the native data store 170 on the user's device or a separate data store associated with the client application. All information may be sent to the user's phone or only a subset of information (configured by the subscriber) may be provided.

The foregoing detailed description of the invention has been presented for purposes of illustration and description. It is not intended to be exhaustive or to limit the invention to the precise form disclosed. Many modifications and variations are possible in light of the above teaching. As noted herein, numerous variations on the architecture of the present invention are possible without departing from the scope and content of the present invention. In one embodiment, requests and responses can be compressed and encrypted.

The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A process for installing personification information to a first wireless device, comprising:
detecting a communication initiation between the first wireless device and a second wireless device user;
in response to said detecting, retrieving published persona information of the second wireless device user; and
storing the published persona information in an address book on the first wireless device.

2. The method of claim 1 wherein the first wireless device user is a persona service subscriber and the information is transferred automatically.

3. The method of claim 2 wherein the first wireless device user is not a subscriber service user.

4. The method of claim 3 said retrieving step requires the first user to subscribe to a persona service.

5. The method of claim 4 further including inviting the first wireless device user to become a persona service subscriber.

6. The method of claim 1 wherein said method further includes prompting the first user to indicate whether the user wishes to receive persona information, and said step of retrieving is responsive to said prompting.

7. The method of claim 2 wherein the second wireless device user is a persona subscriber and said retrieving step retrieves persona information following a prompt to the first user to indicate whether the first user wishes to receive persona information for the second user.

8. The method of claim 1 wherein the step of retrieving includes retrieving persona information from the second wireless device.

9. The method of claim 1 wherein the step of retrieving includes retrieving persona information from an enterprise service provider.

10. The method of claim 1 further including the step of updating the persona information on the second wireless device following changes to the personal information by the first wireless device user.

11. The method of claim 1 wherein the communication is an SMS message.

12. The method of claim 1 wherein the communication is a phone call between the devices.

13. The method of claim 1 wherein the communication is an email between the devices.

14. The method of claim 1 wherein the communication is initiated by the first wireless device to the second wireless device user.

15. The method of claim 1 wherein the communication is initiated by the second wireless device user to the first wireless device user.

16. A computer implemented process for transferring user published persona information to a first wireless device, comprising:
receiving said user published persona information;
detecting a communication between the first wireless device and the user operating a second wireless device; and
forwarding the user published persona information to the first wireless device.

17. The method of claim 16 wherein a first wireless device user is a persona service subscriber and the information is transferred automatically.

18. The method of claim 16 wherein a first wireless device user is not a subscriber service user.

19. The method of claim 18 said forwarding step is initiated only after the first user subscribes to a persona information service.

20. The method of claim 19 further including inviting the first wireless device user to become a persona information service subscriber.

21. The method of claim 16 wherein said method further includes prompting a user on the first wireless device to indicate whether the user wishes to receive persona information, and said step of forwarding is responsive to said prompting

22. The method of claim 16 wherein the step of detecting comprises receiving a signal from an agent on said first wireless device indicating that a communication establishment has occurred.

23. A computer implemented process for automatically installing user defined persona information to a contact store on a wireless device, comprising:
maintaining a data store of user defined persona information for a persona information service subscriber;
detecting a communication between the subscriber and a wireless device user;
providing user defined persona information for the subscriber from data store to the wireless device via the wireless link.

24. The method of claim 23 wherein the wireless device user is also a subscriber and the persona information is transferred automatically.

25. The method of claim 23 wherein the wireless device user is not a subscriber and the method further includes inviting the wireless device user to become a persona information service subscriber.

26. The method of claim 23 wherein the wireless device user is not a subscriber and the method further includes providing user defined persona information for the subscriber to the wireless device user following a request from said subscriber.

27. The method of claim 23 wherein the step of detecting comprises receiving a signal from an agent on said wireless device indicating that a communication establishment has occurred.
